(19) United States
(12) Patent Application Publication
(10) Pub. No.: US 2021/0192430 A1
(43) Pub. Date: Jun. 24, 2021

(54) FORECASTING INVENTORY MODEL SYSTEM

(71) Applicants: Stephen M. Bennice, Melbourne, FL (US); Kyle Morgan, Melbourne, FL (US); Michelle D. Brandt, Melbourne, FL (US); Abhishek Paul, Melbourne, FL (US)

(72) Inventors: Stephen M. Bennice, Melbourne, FL (US); Kyle Morgan, Melbourne, FL (US); Michelle D. Brandt, Melbourne, FL (US); Abhishek Paul, Melbourne, FL (US)

(73) Assignee: NORTHROP GRUMMAN SYSTEMS CORPORATION, Falls Church, VA (US)

(21) Appl. No.: 16/725,118

(22) Filed: Dec. 23, 2019

(51) Int. Cl. G06Q 10/08; G06Q 10/06

(52) U.S. Cl. CPC G06Q 10/087; G06Q 10/067

(57) ABSTRACT

One example includes a forecasting inventory management system for a fleet of assets. An I/O interface receives inputs defining inventory and supply chain parameters of the assets and component(s) of each asset over a duration of time spanning from a present time to a future time. The inputs further include a time-phased input corresponding to a change associated with at least one of the inventory and supply chain parameters at future time(s) in the duration of time. The I/O interface can also provide outputs comprising an inventory assessment model comprising an allocation of the inventory of the component(s) throughout the duration of time. A memory system stores a database defining the inventory and supply chain parameters associated with the assets and the component(s). A forecasting engine generates the inventory assessment model at the present time based on the inventory and supply chain parameters throughout the duration of time.

### TECHNICAL FIELD

The present disclosure relates generally to inventory management systems, and specifically to a forecasting inventory model system.

### BACKGROUND

Large enterprises typically have to perform significant tracking of components through a supply chain to ensure operation of a large number of assets, such as through a duration of many years. For example, branches of the military may have to account for a significant number of parts for any of a variety of assets that can be deployed for long periods of time in remote locations. One such example is to ensure that a given fleet of vehicles (e.g., a type of aircraft or land vehicle) has sufficient quantity of parts to support a full deployment for a period of years, as well as a sufficient number of spares to accommodate repairs, changes to the deployment, and/or escalation at a future time. Tracking such a large amount of inventory while accommodating changes to situational logistics in the future can be a difficult endeavor that requires significant personnel and computing resources.

### SUMMARY

One example includes a forecasting inventory management system for a fleet of assets. An I/O interface receives inputs defining inventory and supply chain parameters of the assets and component(s) of each asset over a duration of time spanning from a present time to a future time. The inputs further include a time-phased input corresponding to a change associated with at least one of the inventory and supply chain parameters at future time(s) in the duration of time. The I/O interface can also provide outputs comprising an inventory assessment model comprising an allocation of the inventory of the component(s) throughout the duration of time. A memory system stores a database defining the inventory and supply chain parameters associated with the assets and the component(s). A forecasting engine generates the inventory assessment model at the present time based on the inventory and supply chain parameters throughout the duration of time.

Another example includes a method for managing inventory of at least one component associated with each of a fleet of assets. The method includes receiving first inputs defining inventory and supply chain parameters associated with the fleet of assets and the at least one component over a duration of time spanning from a present time to a future time. The method also includes receiving second inputs defining at least one time-phased input corresponding to a change associated with at least one of the inventory and supply chain parameters at at least one future time in the duration of time. The method also includes storing the first and second inputs in an associated database stored in a memory system and generating an inventory assessment model comprising an allocation of the inventory of the at least one component throughout the duration of time at the present time based on the inventory and supply chain parameters throughout the duration of time. The method further includes generating an inventory management plan comprising instructions to maintain a predetermined quantity supply of the at least one component throughout the time duration at the present time based on the inventory and supply chain parameters throughout the duration of time, and providing outputs comprising the inventory assessment model and the inventory management plan.

Another example includes a forecasting inventory management system for a fleet of assets. The system includes a memory system configured to store a database defining inventory and supply chain parameters associated with the fleet of assets and at least one component of the fleet of assets. The inventory and supply chain parameters includes at least one of an asset repair time associated with each of at least one asset repair facility and a component production time associated with each of at least one component production facility and at least one of an asset repair capacity associated with each of the at least one asset repair facility and a component production capacity associated with each of the at least one component production facility. The system also includes an I/O interface configured to receive inputs defining the inventory and supply chain parameters associated with the fleet of assets and the at least one component associated with each asset of the fleet of assets over a duration of time spanning from a present time to a future time. The inputs further include at least one time-phased input corresponding to a change associated with at least one of the inventory and supply chain parameters at at least one future time in the duration of time. The I/O interface is further configured to provide outputs comprising an inventory assessment model comprising an allocation of inventory of the at least one component at each of a plurality of supply chain locations associated with the supply chain of the at least one component defined by the second database at each time throughout the time duration. The system further includes a forecasting engine configured to generate the inventory assessment model at the present time based on the inventory and supply chain parameters throughout the duration of time.

### BRIEF DESCRIPTION OF THE DRAWINGS

FIG. 1 illustrates an example of a forecasting inventory model system.

FIG. 2 illustrates an example of a memory system.

FIG. 3 illustrates an example of inputs and outputs associated with a forecasting inventory model system.

FIG. 4 illustrates an example of a time-based inventory graph.

FIG. 5 illustrates another example of a time-based inventory graph.

FIG. 6 illustrates an example of a method for managing inventory of at least one component associated with each of a fleet of assets.

### DETAILED DESCRIPTION

The present disclosure relates generally to inventory management systems, and specifically to a forecasting inventory model system. The forecasting inventory model system includes an input/output (I/O) interface that receives inputs and provides outputs to one or more users. As an example, the inputs can include inventory and supply chain parameters associated with a fleet of assets and at least one component associated with each asset of the fleet of assets over a duration of time spanning from a present time to a future time (e.g., years or decades in the future). For example, the forecasting inventory model system can be used in a military application to track one or more components (e.g., parts) for assets (e.g., vehicles). The inventory and supply chain parameters can include any of a variety of data corresponding to the number of assets and characteristics of the supply chain for producing the component(s) and/or installing the component(s) on each of the assets. The inputs can also include time-phased inputs corresponding to a change associated with the inventory and supply chain parameters at one or more future times in the duration of time. For example, the time-phased inputs can correspond to predicted changes in lead times for production of the component(s), predicted changes in use of the component(s) and/or deployment of the fleet of assets, or any of a variety of predicted conditions that can affect the potential supply of the component(s) at any time in the future that spans the operational duration of time of the forecasting inventory model system.

The I/O interface can also provide outputs that can include an inventory assessment model and/or an inventory management plan. For example, the inventory assessment model can include an allocation of the inventory of the component(s) throughout the duration of time. As an example, the inventory assessment model can provide an allocation of the quantity of the component(s) for each asset and for each of a plurality of storage locations (e.g., for storage of spares) throughout the duration of time. For example, a user could select any of the storage locations at any future time in the duration of time to determine a quantity of the component(s) stored there based on the inventory assessment model. The inventory management plan can correspond to instructions to maintain a predetermined quantity supply of the component(s) throughout the time duration. For example, the inventory management plan can include ordering instructions for the component(s) throughout the time duration (e.g., corresponding to future times to order, quantity of the component(s) to be ordered, etc.) and component management instructions corresponding to allocation instructions of the component(s) to each asset and to the storage location(s) throughout the time duration. For example, the assets can be organized into priority tiers, such as based deployment states, that can dictate the instructions for allocating the component(s) to the assets as set forth in the inventory management plan.

The forecasting inventory model system can also include a forecasting engine that can be configured as a processor or set of processors to generate the inventory assessment model and the inventory management plan based on the inventory and supply chain parameters. For example, the forecasting engine can generate the inventory assessment model and/or the inventory management plan at the present time to provide the relevant information of the inventory assessment model and/or the inventory management plan for each future time throughout the duration of time. The forecasting engine can accommodate the time-phased inputs in generating the inventory assessment model and/or the inventory management plan, such that the inventory assessment model and/or the inventory management plan provided at the present time accounts for the changes to the inventory and supply chain parameters at the corresponding future times in the duration of time. The inventory assessment model and/or the inventory management plan can each be stored in a memory system, along with the inventory and supply chain parameters and associated time-phased inputs corresponding to the fleet of assets and the component(s) of the fleet of assets.

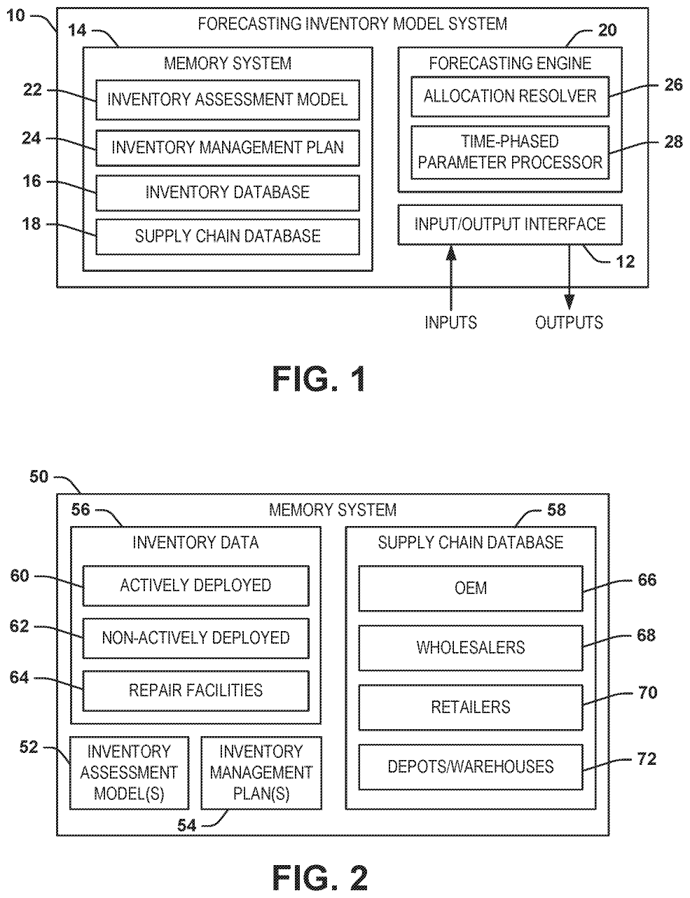

FIG. 1 illustrates an example of a forecasting inventory model system 10. The forecasting inventory model system 10, as described herein, can be implemented for managing the inventory of at least one component associated with a fleet of assets. The forecasting inventory model system 10 can be implemented in any of a variety of large enterprise inventory management scenarios. For example, the forecasting inventory model system 10 can be employed for tracking parts corresponding to the component(s) for a fleet of military vehicles corresponding to the assets. However, the assets are not limited to vehicles, but can instead correspond to personnel (e.g., soldiers) or facilities (fixed or movable structures or buildings). As described herein, the forecasting inventory model system 10 can be configured to manage the inventory of the component(s) throughout a time duration that can span years (e.g., decades) from a present time to a distant (e.g., dynamic) future time, and all future times between. As an example, the duration of time can be static or programmable, and can correspond to a predetermined static amount of time from the present time, such that the distant future time can progress at the same rate as the current time.

The forecasting inventory model system 10 includes an input/output (I/O) interface 12 that receives inputs, demonstrated in the example of FIG. 1 as “INPUTS”, and provides outputs, demonstrated in the example of FIG. 1 as “INPUTS”, to one or more users. For example, the I/O interface 12 can be configured as or including one or more computer terminals, monitors, peripheral input devices, data drives, or any of a variety of devices that can receive data as an input and provide data as an output. As an example, the inputs can include inventory and supply chain parameters associated with a fleet of assets and at least one component associated with each asset of the fleet of assets over a duration of time spanning from a present time to a future time (e.g., years or decades in the future). The inventory and supply chain parameters can include any of a variety of data corresponding to the number of assets and characteristics of the supply chain for producing the component(s) and/or installing the component(s) on each of the assets.

In the example of FIG. 1, the forecasting inventory model system 10 also includes a memory system 14. The memory system 14 can be configured as and/or can include any of a variety of different types of memory or media components configured to store data. The memory system 14 is demonstrated as storing an inventory database 16 and a supply chain database 18. As an example, the inventory database 16 and supply chain database 18 can be collectively configured to store the inventory and supply chain parameters associated with the fleet of assets and the component(s). For example, the inventory database 16 can store parameters associated with a quantity and characteristics of the fleet of assets. As an example, and as described in greater detail herein, the assets can be categorized in a variety of ways, with such categories having priorities. The categories and priorities thereof that can be dictated by the inventory and supply chain data provided in the inputs and stored in the inventory database 16. As an example, the supply chain database 18 can include information regarding a supply chain of the component(s), such as including manufacturer(s), wholesaler(s), retailer(s), and storage facilities of the component(s).

The inputs can also include time-phased inputs corresponding to a change associated with the inventory and supply chain parameters at one or more future times in the duration of time. The time-phased inputs can be stored with the relevant parameters (e.g., inventory and supply chain parameters), for example, in the inventory database 16 and/or the supply chain database 18. For example, the time-phased inputs can correspond to predicted changes in lead times for production of the component(s), predicted changes in use of the component(s) and/or deployment of the fleet of assets, or any of a variety of predicted conditions that can affect the potential supply of the component(s) at any time in the future that spans the operational duration of time of the forecasting inventory model system 10. Examples of time-phased inputs can include a predicted completion time of an additional factory that can increase a production capacity of the component(s), predicted availability of a technology that can reduce repair times of an associated asset, a predicted time of addition of a retailer that can supply the component(s), completion of manufacturing of additional assets, a scheduled deployment of a portion of the assets, or any predicted change of any of the inventory and supply chain parameters at any time in the duration of time that can have any effect on the supply or allocation of the component(s) to the assets or to storage of the component(s).

In the example of FIG. 1, the forecasting inventory model system 10 includes a forecasting engine 20. The forecasting engine 20 can, for example, be configured as a processor or set of processors. The forecasting engine 20 is configured to process the inventory and supply chain parameters (e.g., accessed from the inventory database 16 and the supply chain database 18) and to generate an inventory assessment model 22 and an inventory management plan 24. For example, the inventory assessment model 22 can include an allocation of the inventory of the component(s) throughout the duration of time. As an example, the inventory assessment model 22 can provide an allocation of the quantity of the component(s) for each asset and for each of the storage locations (e.g., stored in the inventory database 16) throughout the duration of time. In the example of FIG. 1, the forecasting engine 20 includes an allocation resolver 26 that is configured to generate the inventory assessment model 22 and the inventory management plan 24 based on the inventory and supply chain parameters. For example, the allocation resolver 26 can implement an algorithm that can iteratively operate to determine a most efficient and optimal plan for the allocation of the component(s) to the respective assets, repair facilities, and storage locations, such as to achieve a least amount handling of the component(s) while maintaining the allocation requirements (e.g., by procuring and allocating the component(s) to the assets).

As described herein, the term “repair” with respect to assets describes both the repair of previously existing/operating assets and manufacture/assembly of new assets. Therefore, repair facilities can describe either facilities that repair previously operational assets or manufacture new assets.

For example, the inventory assessment model 22 can provide a daily quantity of the component(s), and where each of the component(s) are allocated, at any given time in the duration of time. As an example, a user could select any of the storage locations at any future time in the duration of time to determine a quantity of the component(s) stored in that respective storage location based on the data represented by the inventory assessment model. The user could instead select any given future time (e.g., day) in the duration of time to determine a total quantity of the component(s) at that particular time, and can determine where each of the component(s) are allocated by storage location, asset, and/or repair facility. As another example, the inputs can include one or more thresholds that can define functional requirements of the quantity of the component(s), such as to define a minimum quantity for utilization by all assets and/or to include a safe minimum quantity of spares. Therefore, the inventory assessment model 22 can also provide an evaluation of a projected quantity supply of the component(s) relative to the threshold(s) at each time throughout the duration of time.

The inventory management plan 24 can correspond to instructions to maintain a predetermined quantity supply of the component(s) throughout the time duration. For example, the inventory management plan 24 can include ordering instructions for procuring the component(s) throughout the time duration (e.g., corresponding to future times to order, quantity of the component(s) to be ordered, etc.). As another example, the inventory management plan 24 can include allocation instructions of the component(s) to each asset and to the storage location(s) throughout the time duration. For example, the allocation instructions can dictate when (e.g., future times during the duration of time) to allocate a given quantity of the component(s) to storage locations, repair facilities, and/or to the assets (e.g., from the storage locations and/or from other assets). As an example, the assets can be organized into priority tiers, such as based deployment states, that can dictate the instructions for allocating the component(s) to the assets as set forth in the inventory management plan. Therefore, based on identifying an imminent scheduled deployment of a set of assets at a future time, the inventory management plan 24 can provide instructions as to how to ensure that the assets to be deployed are allocated a full complement of component(s) (e.g., including spares) at sufficient future times prior to the future scheduled deployment.

As another example, the inputs can also include hypothetical changes to the inventory and supply chain parameters, such that the forecasting inventory model system 10 can be implemented to perform “what if” analyses with respect to the inventory of the component(s). For example, the memory system 14 can be configured to maintain the inventory assessment model 22 and the inventory management plan 24, and can also store one or more hypothetical inventory assessment models and/or inventory management plans. The inputs can also include hypothetical inventory and supply chain parameters or hypothetical changes to the inventory and supply chain parameters. Therefore, the forecasting engine 20 can generate a hypothetical inventory assessment model and a hypothetical inventory management plan at the present time, similar to as described previously, based on the hypothetical inventory and supply chain parameters or hypothetical changes to the inventory and supply chain parameters. As another example, the hypothetical inventory and supply chain parameters or hypothetical changes to the inventory and supply chain parameters can include cost data associated with the fleet of assets and/or the component(s). Accordingly, the hypothetical inventory management plan can also multiple inventory management plan options, such as mutually exclusive with respect to each other, that each include execution costs. As a result, the users of the forecasting inventory model system 10 can evaluate each of the mutually exclusive inventory management plan options to determine a preferred course of action for maintaining the inventory supply throughout the duration of time, such as based on efficiency and/or costs.

As an example, the forecasting engine 20 can accommodate the time-phased inputs in generating the inventory assessment model 22 and/or the inventory management plan 24. In the example of FIG. 1, the forecasting engine 20 also includes a time-phased parameter processor 28 that is configured to cooperate with the allocation resolver 26 to incorporate the time-phased inputs into the iterative algorithm performed by the allocation resolver 26. Therefore, the allocation resolver 26 can generate the inventory assessment model 22 and/or the inventory management plan 24 at the present time to account for the changes to the inventory and supply chain parameters at the corresponding future times throughout the duration of time, as provided by the time-phased parameter processor 28. Therefore, at any given time corresponding to the present time, the inventory assessment model 22 and the inventory management plan 24 can provide a complete set of data for how the component(s) are to be allocated and how the inventory is to be obtained and managed, respectively, for all future times throughout the duration of time both before and after predicted future changes to the inventory and supply chain parameters. Therefore, despite the changes to the inventory and supply chain parameters occurring in the future, such changes are accounted for at the present time that the allocation resolver 26 generates the inventory assessment model 22 and the inventory management plan 24. As a result, such predicted changes to the inventory and supply chain parameters can be accommodated in the inventory assessment model 22 and the inventory management plan 24 before the actual changes take effect. Accordingly, the operations of the personnel and the facilities that implement the actual inventory management plan 24 can properly prepare for the changes in a simplistic manner, as opposed to being required to implement drastic operational changes to accommodate the sudden changes in the inventory and supply chain parameters in real-time.

The inventory assessment model 22 and the inventory management plan 24 (e.g., actual and hypothetical) can be provided from the I/O interface 12 as outputs to the one or more users. As another example, the forecasting engine 20 can be configured to automatically update the inventory assessment model 22 and/or the inventory management plan 24 at the present time in response to inputs provided to the I/O interface 12. For example, any minor changes to the inventory and supply chain parameters that are input to the I/O interface 12 can be substantially immediately processed by the forecasting engine 20. As an example, an input that provides a minor change to one of the inventory and supply chain parameters can be processed by the allocation resolver 26, such as processing only the relevant portions of the algorithm to provide any associated changes to the inventory assessment model 22 and/or the inventory management plan 24. Therefore, the allocation resolver 26 can conserve time and processing power by not processing the entire inventory assessment model 22 and/or inventory management plan 24. Additionally or alternatively, the allocation resolver 26 can process the inventory and supply chain parameters at periodic intervals of time (e.g., daily) to update the inventory assessment model 22 and/or inventory management plan 24. The I/O interface 12 can therefore provide outputs to the user(s), which can include either the entirety of the inventory assessment model 22 and the inventory management plan 24, or just the relevant changes based on the updated inputs.

FIG. 2 illustrates an example of a memory system 50. The memory system 50 can correspond to the memory system 14 in the example of FIG. 1. Therefore, reference is to be made to the example of FIG. 1 in the following description of the example of FIG. 2.

The memory system 50 includes at least one inventory assessment model 52 and at least one inventory management plan 54 that are stored therein. As an example, the inventory assessment model(s) 52 and inventory management plan(s) 54 can correspond to both actual and hypothetical versions, and can each correspond to separate versions for respective components associated with the fleet of assets. For example, the inventory assessment model(s) 52 and the inventory management plan(s) 54 can be generated by the forecasting engine 20 in response to inputs corresponding to inventory and supply chain parameters. As an example, the inventory assessment model(s) 52 and the inventory management plan(s) 54 can be provided as outputs to user(s) via the I/O interface 12.

The memory system 50 also includes an inventory database 56 and a supply chain database 58. As an example, the inventory database 56 and supply chain database 58 can be collectively configured to store the inventory and supply chain parameters associated with the fleet of assets and the component(s). In the example of FIG. 2, the inventory database 56 includes actively deployed assets data 60, non-actively deployed assets data 62, and repair facilities data 64. As described previously, the assets can be categorized (e.g., via the inputs) into a plurality of categories. The categories can correspond to deployment states of the assets, such that the actively deployed assets data 60 and non-actively deployed assets data 62 can each correspond to one or more different categories of the assets. For example, the actively deployed assets data 60 and non-actively deployed assets data 62 can include data that corresponds to deployment state, future deployment details, data regarding projected or anticipated usage of the assets in the respective states, location of the assets in the respective categories or deployment states, and/or any of a variety of other information regarding the assets in the respective categories, deployment status, location, and/or usage. For example, such information can be stored in the inventory database 56 based on the inventory and supply chain parameters input to the I/O interface 12.

The repair facilities data 64 can include a variety of data regarding repair facilities that can repair assets, such as by installing the component(s) and/or replacement component(s). As an example, the repair facilities data 64 can include at least a minimum time associated with performing a repair of a given one asset, as well as a capacity of the number of assets that can be repaired concurrently for each given repair facility. As a result, the repair facilities data 64 can provide information as to an expected amount of time that it would take to concurrently repair any given number of assets at each given repair facility. Therefore, unlike typical inventory management models/programs that only account for one of the constraints associated with minimum repair time and capacity of assets for concurrent repair, the forecasting engine 20 can account for can calculate a repair time solution that does not violate both of the constraints associated with minimum repair time and capacity of assets for concurrent repair. As another example, the repair facilities data 64 can also describe locations of the repair facilities, such as to account for logistical timing in providing assets in need of repair to the repair facilities and providing repaired assets to other locations. Therefore, the forecasting engine 20 can account for the repair times and logistical transportation times in generating the inventory assessment model(s) 52 and inventory management plan(s) 54.

In the example of FIG. 2, the supply chain database 58 includes original equipment manufacturer (OEM) data 66, wholesaler data 68, retailer data 70, and depot/warehouse data 72. The OEM data 66 can correspond to data regarding manufacturers of the component(s), such as including location, availability, lead-times, etc. The wholesaler data 68 and the retailer data 70 can correspond to data regarding sellers of the component(s). For example, the wholesaler data 68 and retailer data 70 can collectively include locations, availability, cost, and/or other information about the sale of the component(s). For example, the OEM data 66, the wholesaler data 68, and the retailer data 70 can collectively describe a minimum time associated with producing the component(s), as well as a capacity of the number of component(s) that can be produced concurrently, and thus available at any given time. As a result, the OEM data 66, the wholesaler data 68, and the retailer data 70 can provide information as to an expected amount of time that it would take to procure any given number of component(s). Additionally, the depot/warehouse data 72 can include data regarding storage of the component(s), such as queued to be allocated to assets and/or stored as spares. As an example, the depot/warehouse data 72 can include locations of depots/warehouses, capacity, availability, and any other information regarding how the component(s) can be stored.

As described previously, the inventory database 56 and the supply chain database 58 can each be configured to store the inventory and supply chain parameters that are provided via the inputs to the I/O interface 12. As a result, the forecasting engine 20 is configured to access the inventory and supply chain parameters from the inventory database 56 and the supply chain database 58 to generate the inventory assessment model 52 and the inventory management plan 54. The inventory assessment model 52 and inventory management plan 54 are thus stored in the memory system 50, and are accessible by the user(s) as outputs from the forecasting inventory model system 10.

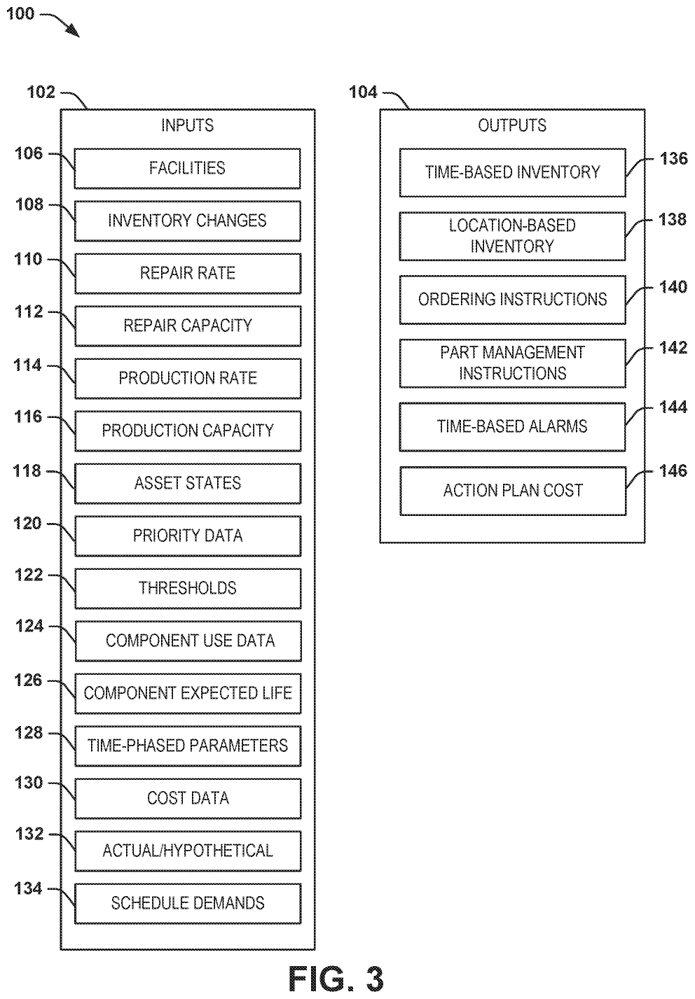

FIG. 3 illustrates an example of diagram 100 of inputs and outputs associated with a forecasting inventory model system. The diagram 100 demonstrates inputs 102 that are demonstrated diagrammatically to represent the different types of inputs corresponding to the inventory and supply chain parameters that can be provided to the forecasting inventory model system 10 via the I/O interface 12. The inputs 102 can thus be stored in the memory system 50, such as in the inventory database 52 and/or the supply chain database 54. Similarly, the diagram 100 demonstrates outputs 104 that are demonstrated diagrammatically to represent the different types of outputs provided to user(s) of the forecasting inventory model system 10 via the I/O interface 12. Therefore, reference is to be made to the examples of FIGS. 1 and 2 in the following description of the example of FIG. 3.

The inputs 102 include facilities data 106. The facilities data 106 can include a variety of data regarding OEM facilities that produce the component(s), storage facilities that can store the component(s) and/or the assets, as well as repair facilities that can repair assets, such as by installing the component(s) and/or replacement component(s). For example, the facilities data 106 can include geographical location and storage capacity information, as well as information regarding accessibility of the assets and/or component(s).

The inputs 102 also include inventory changes 108 that may correspond to changes in the inventory of the component(s). As an example, the inventory changes 108 may result in a mismatch between the allocations of the component(s), such as in the inventory assessment model 52, and an actual inventory of the component(s) at a particular location (e.g., associated with the storage/repair facilities data 106). The inputs 102 also include repair rate data 110 that can correspond to a minimum time associated with performing a repair of a given one asset, and repair capacity data 112 that can correspond to a capacity of the number of assets that can be repaired concurrently for each given repair facility. Therefore, similar to as described previously, the repair rate data 110 and repair capacity data 112 can provide information as to an expected amount of time that it would take to concurrently repair any given number of assets at each given repair facility. Similarly, the inputs 102 also include production rate data 114 that can correspond to a minimum time associated with producing a component (e.g., from an OEM), and production capacity data 116 that can correspond to a capacity of the number of the component(s) that can be produced concurrently from each given OEM facility. Therefore, similar to as described previously, the production rate data 114 and production capacity data 116 can provide information as to an expected amount of time that it would take to concurrently produce any given number of the component(s) at each given production facility.

The inputs 102 also include asset states data 118 and priority data 120. The asset states data 118 can correspond to a number of different categories of the assets, such as corresponding to deployment. For example, the asset categories can include actively deployed, imminently deployed (e.g., scheduled to be deployed), non-deployed (e.g., in storage), active for training purposes, under repair, under construction, and/or including subcategories therein. The priority data 120 can therefore assign priorities to the respective categories defined by the asset states data 118 to provide allocation priorities of installation of the component(s), and thus provide a prioritization of the associated component(s) to the higher priority categories of assets. For example, component(s) to be allocated can be prioritized to the assets that are to be deployed at an imminent time. As an example, in response to a determination of an imminent deployment of a portion of the assets having an assigned high priority, the inventory management plan 54 can dictate that a predetermined portion of the component(s) are to be allocated to the imminently deployed assets at a future time that is prior to the scheduled deployment, and can include instructions as to from where the component(s) are to be procured. For example, the inventory management plan 54 can dictate that the component(s) should come from particular storage facilities at a predetermined future time. In an example of a limited supply of the component(s), the inventory management plan 54 can also dictate instructions as to procuring the component(s) that are already in use on lower priority assets, such that the component(s) are disassembled from the lower priority assets and are then installed on the higher priority assets (e.g., based on the repair rate and/or capacity). As a result, the inventory management plan 54 can rely on the priority data 120 to ensure a most efficient plan for maintaining the active fleet of assets with respect to the allocation of the component(s).

As an example, in the context of providing inventory requirements for a military branch that prepares for deployment, such as on a ship (e.g., an aircraft carrier). Thus, upon deployment of the ship to a location across an ocean, it can be logistically prohibitive to procure additional component(s) that may be needed. Therefore, the forecasting engine 20 can identify a scheduled future deployment and identify the assets that are to be deployed (e.g., based on the asset states data 118 and priority data 120). Based on the identified future deployment, the forecasting engine 20 can then calculate how many of the component(s) are needed for the deployment (e.g., depending on the dates of the deployment and component use data, as described in greater detail herein) and can identify the component(s) that are to be reserved in current time for the deployment by assigning a high priority to the component(s) that are stored at a given location, despite there being no current utilization of the component(s), based on the asset states data 118 and the priority data 120. The forecasting engine 20 can then provide instructions (e.g., in the inventory management plan 54) to allocate the component(s) from inventory when the ship prepares to deploy, such that the component(s) are deployed with the ship to satisfy the deployment requirements. Such a future-looking implementation of the forecasting engine 20 can provide a significant advantage over typical inventory models that are reactionary in current time, and therefore do not account for future high priority utilization of currently unused component(s).

The inputs 102 also include thresholds data 122. As an example, the thresholds data 122 can correspond to one or more predetermine thresholds that can dictate the fully operational fleet of assets. For example, a first threshold can correspond to a minimum threshold of a quantity of the component(s) that can allow each of the assets to operate as intended, and thus without any spares and no accounting for unforeseen circumstances. Thus, additional thresholds can correspond to one or more minimum desired quantities of the component(s) to provide for spares of the component(s) to accommodate unforeseen circumstances and/or expected attrition. As an example, the thresholds can also be localized to specific facilities, such that the inventory assessment model 52 can dictate different thresholds for different storage facilities.

The inputs 102 also include component use data 124 and component expected life data 126. The component use data 124 can correspond to an amount of expected use of the component(s), as provided by an active asset. For example, the component use data 124 can correspond to a number of hours, days, or years of operational use of the component(s) as part of the respective asset to which it is allocated. The component use data 124 can have multiple tiers of use time based on the conditions of use that is anticipated, such as based on environment (e.g., temperature, humidity, etc.), or active versus passive use conditions. The component expected life data 126 can correspond to an expected lifetime of the component(s) before it is deemed necessary to be replaced. Similar to the component use data 124, the component expected life data 126 can have multiple tiers of expected life based on the conditions of use that is expected of it. Based on the component use data 124 and the component expected life data 126, the inventory assessment model 52 and the inventory management plan 54 can account for attrition of the component(s) to provide for demand in procuring replacements for the component(s).

For example, as described previously, the component use data 124 and component expected life data 126 can, in combination, provide the basis for planning for a quantity of the component(s) that are needed for a future deployment of the associated assets (e.g., on a ship). For example, for aircraft assets, based on the component use data 124 and component expected life data 126, the forecasting engine 20 can determine how many flight hours are planned to fly the aircraft assets versus how many aircraft assets are intended to fly based on the input parameters associated with the component(s) inventory and logistics structure. As another example, the forecasting engine 20 can determine when lower priority operations cease to support higher priority operations (e.g., based also on the priority data 120). For example, the inventory management plan 54 can provide instructions to short component(s) inventory for lower priority locations to ensure sufficient inventory for future deployment, which can result in cutting flight hours for low priority operations due to lack of available component(s), if necessary. However, the inventory management plan 54 can thus predict and provide notice when lower priority operations are halted not due to a sheer lack of parts, but based on reserving component(s) for a much higher priority future deployment. Accordingly, planning for both low and high priority future logistical operations can be effectively managed at the current time.

The inputs 102 also include time-phased parameters 128. The time-phased parameters 128 can correspond to an expected change in any of the inputs 102 at a given predetermined future time. For example, the time-phased parameters 128 can correspond to predicted changes in lead times for production of the component(s), repairs times for repair of the assets (e.g., for installation of the component(s)), predicted changes in use of the component(s) and/or deployment of the fleet of assets, or any of a variety of predicted conditions that can affect the potential supply of the component(s) at any time in the future that spans the operational duration of time of the forecasting inventory model system 10. Other examples of time-phased parameters 128 can include a predicted completion time of an additional factory that can increase a production capacity of the component(s), predicted availability of a technology that can reduce repair times of an associated asset, a predicted time of addition of a retailer that can supply the component(s), completion of manufacturing of additional assets, a scheduled deployment of a portion of the assets, or any predicted change of any of the inventory and supply chain parameters at any time in the duration of time that can have any effect on the supply or allocation of the component(s) to the assets or to storage of the component(s). Therefore, the time-phased parameters 128 can correspond to any future time-based change to any of the other inputs 102 that can affect the future allocation of the component(s), as dictated by the inventory assessment model 52, and/or the projected future allocation to maintain the inventory of the component(s), as dictated by the inventory management plan 54.

In the example of FIG. 3, the inputs 102 also include cost data 130. The cost data 130 can correspond to the costs associated with producing, purchasing, repairing, and/or allocating the component(s) to the assets. For example, the cost data 130 can include not only the monetary costs for producing and purchasing the component(s), but can also include ancillary costs of handling the component(s). For example, the cost data 130 can include transportation costs, worker wages for installing, handling, or transporting the component(s), repair costs for installing the component(s), leasing costs for storing the component(s), or any of a variety of additional other costs associated with every step of the supply chain for allocating the component(s). The cost data 130 can be implemented by the forecasting engine 20 to provide an expected cost of the inventory management plan 54.

The inputs 102 can also include actual/hypothetical data 132 that can dictate whether the other inputs 102 are provided based on real world occurrences and/or future expected occurrences as actual data, or hypothetical data corresponding to determining optimal solutions in a series of “what if” scenarios. For example, the forecasting engine 20 can generate a hypothetical inventory assessment model and a hypothetical inventory management plan at the present time, similar to as described previously, based on the inputs 102 that can be indicated as hypothetical inputs based on the actual/hypothetical data 132. Accordingly, the forecasting engine 20 can identify the inputs 102 as being actual inputs, and thus provided for generating the actual inventory assessment model 52 and the actual inventory management plan 54, or as hypothetical inputs to generate multiple hypothetical inventory assessment models and/or inventory management plan options, such as mutually exclusive with respect to each other. The forecasting engine 20 can also integrate the cost data 130 into the hypothetical inventory management plans, such that the users of the forecasting inventory model system 10 can evaluate each of the mutually exclusive inventory management plan options to determine a preferred course of action for maintaining the inventory supply throughout the duration of time, such as based on efficiency and/or costs.

The inputs 102 can further include schedule demands data 134. The schedule demands data 122 can correspond to times or schedules that the user(s) of the forecasting inventory model system 10 can dictate to outside parties in order to modify other rate data (e.g., the repair rate data 110 or production rate data 114). For example, the schedule demands 134 can be provided as hypothetical changes to the rate data to determine if such hypothetical changes can materially affect the inventory assessment model 52 and/or the inventory management plan 54. As another example, the forecasting engine 20 can accommodate both given rate data (e.g., the repair rate data 110 or production rate data 114), as provided by outside parties, and a more aggressive rate dictated by the schedule demands data 134. Therefore, the inventory assessment model 52 and the inventory management plan 54 can provide a range of allocation and/or instructions, respectively, based on an amalgam of the rate data and the schedule demands data 134.

The outputs 104 can correspond to any of the outputs provided from the I/O interface 12, such as including the inventory assessment model 52 and/or the inventory management plan 54. In the example of FIG. 3, the outputs 104 can include time-based inventory 136 and location-based inventory 138. The time-based inventory 136 and the location-based inventory 138 can each correspond to a portion of the inventory assessment model 52. For example, the time-based inventory 136 can include an inventory of the component(s) at any given future time during the duration of time. As an example, the time-based inventory 136 can be provided as having any of a variety of granularity levels, such as daily or even hourly based on predetermined determinations of delivery times (e.g. as provided by the facilities data 106). As described in greater detail herein, the time-based inventory data 136 can be demonstrated as the entirety of the duration of time, and/or a portion of the duration of time (e.g., a span of one week, one month, or one year), or at a given moment in time during the duration of time. The location-based inventory 138 can correspond to an inventory of the component(s) at any given location (e.g., as provided in the facilities data 106) in the supply chain. As an example, the location-based inventory 138 can be combined with the time-based inventory 136, such that the inventory of the component(s) can be determined at each location at any given time throughout the duration of time.

The outputs 104 can include ordering instructions 140 and part management instructions 142. The ordering instructions 140 and the part management instructions 142 can each correspond to a portion of the inventory management plan 54. The ordering instructions 140 can correspond to instructions for ordering the component(s). For example, the ordering instructions 140 can include a schedule for ordering a particular quantity of the component(s) throughout the duration of time. As another example, the ordering instructions 140 can include instructions as to which wholesalers or retailers that the component(s) should be ordered from, and at what respective quantities, at a given time. The part management instructions 142 thus correspond to instructions for how and when the obtained component(s) are allocated to the assets and/or to storage facilities. The part management instructions 142 can provide for detailed time-based instructions as to logistics for transporting the component(s) to repair facilities and/or storage facilities, as well as time-based instructions as to removal of the component(s) from storage locations and installation of the component(s) into assets at respective repair facilities. Therefore, the part management instructions 142 can include all aspects of allocation of the component(s) to storage and to the assets.

The outputs 104 also include time-based alarms 144. The time-based alarms 144 can include alarms that are provided to the user(s) of the forecasting inventory model system 10 in response to conditions that are insufficient to maintain the predetermined necessary quantity of the component(s). For example, in response to the quantity of the component(s) being less than one or more of the thresholds dictated by the thresholds data 122, the time-based alarms 144 can indicate to a user that the supply of the component(s) is insufficient. As an example, the time-based alarms 144 can be provided in response to a real-time shortage of the quantity of the component(s), or can be provided previous to a time at which there will be a shortage of the quantity of the component(s). As a result, the time-based alarms 144 can indicate an anticipated shortage of the quantity of the component(s) at a time prior to the actual shortage, such as to provide time for the user(s) to address, and potentially mitigate or alleviate, the shortage.

The outputs 104 further include an action plan cost 146. The action plan cost 146 can correspond to a cost associated with the inventory management plan 54. Additionally, as described previously, the forecasting engine 20 can be configured to generate hypothetical inventory management plans, such that the action plan cost 146 can include a hypothetical cost associated with each of the hypothetical inventory management plans. As a result, the user(s) can evaluate different hypothetical inventory management plans to determine a hypothetical inventory management plan that is best suited for implementing as an actual inventory management plan.

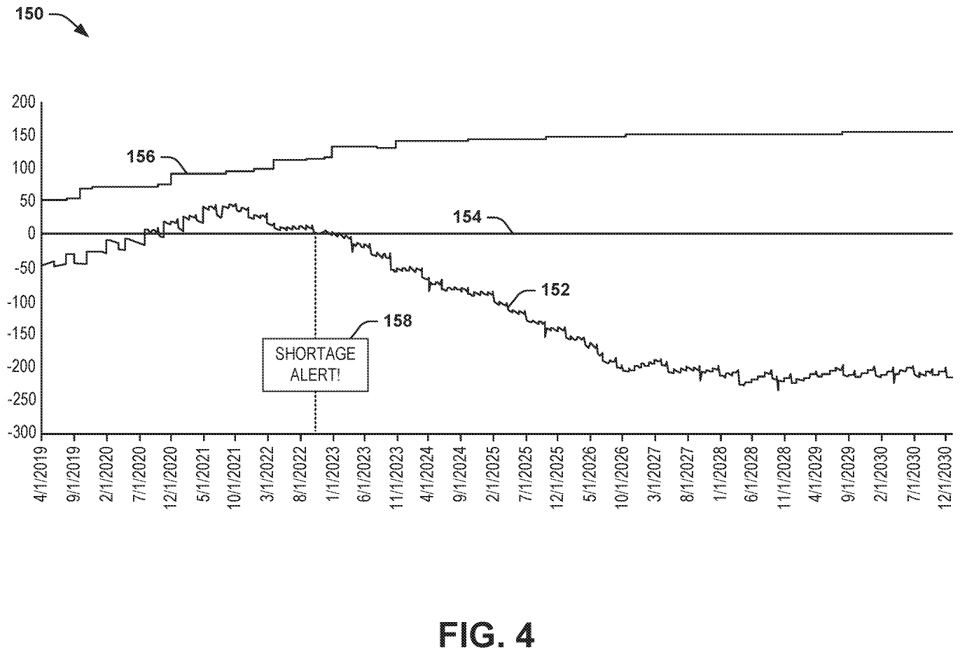

FIG. 4 illustrates an example of a time-based inventory graph 150. The time-based inventory graph 150 can correspond to one form of the inventory assessment model 52. For example, the graph 150 can be generated by the forecasting engine 20 and can be provided as an output as part of the inventory assessment model 52. Therefore, reference is to be made to the example of FIGS. 1-3 in the following description of the example of FIG. 4.

The graph 150 plots a quantity of the component(s), demonstrated at 152, relative to a minimum utilization threshold 154. Thus, the Y-axis of the graph 150 demonstrates the minimum utilization threshold 154 at a quantity zero, indicating that there are no additional spare component(s) at the minimum utilization threshold 154 given that all of the component(s) are allocated to a respective asset. The quantity of the component(s) 152 is plotted along the X-axis at a time that can correspond to the duration of time, which can span a decade or more in the future. As an example, the quantity of the component(s) 152 can be extrapolated based on a current inventory management plan (e.g., the inventory management plan 54) that provides instructions as to how to procure and allocate the component(s) throughout the duration of time.

As an example, the graph 150 can be interactive to user(s) to provide additional information. For example, the graph 150 can allow user input(s) to select a given time to see a total quantity of the component(s) 152 at that particular time, such as including a breakdown of the quantity at each of a given plurality of locations (e.g., in storage or as allocated to assets in a given location or category). Additionally or alternatively, the graph 150 can allow a user to select a location and determine the quantity of the component(s) 152 at just that location over the duration of time. Therefore, a user can determine not just the quantity of the component(s) 152 throughout the duration of time, but also a variety of other details regarding the quantity and/or allocation of the component(s) throughout the duration of time.

The graph 150 thus demonstrates the quantity of the component(s) 152 relative to minimum utilization threshold 154 as a positive, indicating at least one spare, or a negative, indicating a deficit to maintaining all of the assets as operational. Therefore, a negative quantity of the component(s) indicates insufficiency of all of the operational assets. As a result, a user can include an additional threshold, demonstrated at 156, that can provide a predetermined desired storage quantity of the component(s). In the example of FIG. 4, the threshold 156 is demonstrated as changing (e.g., increasing) over time, such as based on anticipated changes in desired quantity of spares. Therefore, it may be the goal of the inventory management plan 54 to maintain the quantity of the component(s) 152 to be greater than the threshold 156.

In the example of FIG. 4, the graph 150 demonstrates that the current inventory management plan is insufficient to maintain the quantity of the component(s) 152 to greater than the threshold 156. Additionally, at a time in the future relative to a starting time of the graph (as of Apr. 1, 2019), the quantity of the component(s) 152 is reduced to less than the minimum utilization threshold 154. As a result, a time-based alarm, demonstrated at 158, is provided to indicate to the user that, according to the current inventory management plan 54, the quantity of the component(s) 152 will be insufficient to maintain the full complement of assets as operational as of approximately October, 2022. Therefore, the user can be alerted that a change in the inventory management plan is required.

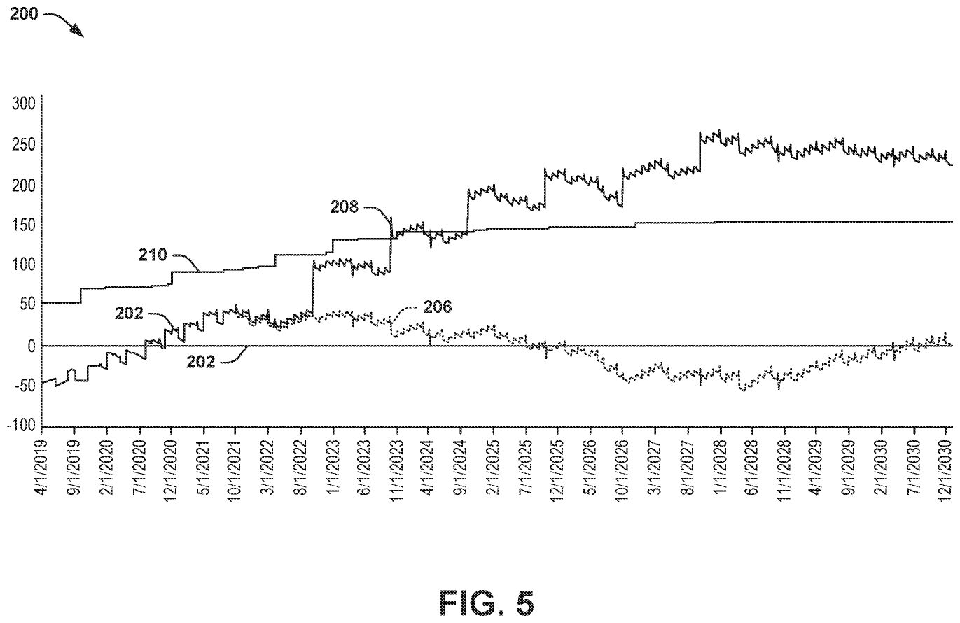

FIG. 5 illustrates an example of a time-based inventory graph 200. The time-based inventory graph 200 can correspond to one form of the inventory assessment model 52. For example, the graph 200 can be generated by the forecasting engine 20 and can be provided as an output as part of the inventory assessment model 52. Therefore, reference is to be made to the example of FIGS. 1-4 in the following description of the example of FIG. 5.

The graph 200 can correspond to a change in the inventory management plan 54, such as resulting from the input of one or more time-phased parameters (e.g., the time-phased parameters 128). In the example of FIG. 5, the quantity of the component(s), demonstrated at 202, is demonstrated relative to a minimum utilization threshold 204. In response to a change to the inventory and supply chain parameters, the quantity of the component(s) 202 is demonstrated as increasing greater than the minimum utilization threshold 204. However, on approximately Oct. 1, 2021, the quantity of the component(s) 202 is demonstrating as splitting between two separate quantities, demonstrated as a solid line 206 and a dotted line 208. The dotted line 206 can correspond to a continuation of the inventory management plan generated in response to the new inventory and supply chain parameters. As demonstrated in the example of FIG. 5, the quantity of component(s) 206 is still not sufficient to maintain a fully operational fleet of assets.

As an example, the quantity of the component(s) 208 can correspond to a hypothetical inventory management plan. For example, the quantity of the component(s) 208 can deviate from the quantity of the component(s) 206 based on a time-phased parameter that is input to the forecasting inventory model system 10. As an example, the time-phased parameter can correspond to an increase in a quantity of ordered component(s), such as at approximately October, 2022. Therefore, in response to the time-phased parameter, the graph 200 demonstrates that not only does the quantity of the component(s) 208 increase to greater than the minimum utilization threshold 204, but it eventually increases to greater than an additional threshold 210 corresponding to a desired quantity of spares. Therefore, by identifying that the time-phased parameter can substantially beneficially affect the quantity of the component(s) 208 over the course of the duration of time. As a result, the inventory management plan 54 can be provided to include the instructions for ordering the additional parts at the appropriate future time to provide the predictable result demonstrated by the graph 200 with respect to the quantity of the component(s) 208.

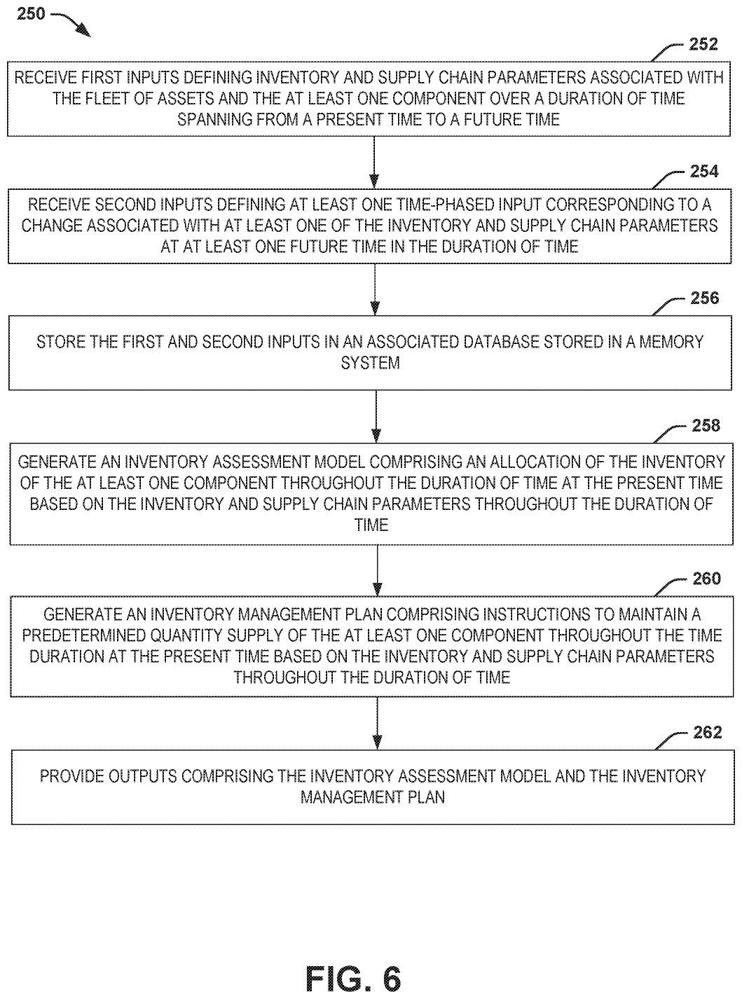

In view of the foregoing structural and functional features described above, an example method will be better appreciated with reference to FIG. 6. While, for purposes of simplicity of explanation, the method is shown and described as executing serially, it is to be understood and appreciated that the method is not limited by the illustrated order, as parts of the method could occur in different orders and/or concurrently from that shown and described herein. Such method can be executed by various components configured in an integrated circuit, processor, or a controller, for example.

FIG. 6 illustrates an example of a method 250 for managing inventory of at least one component associated with each of a fleet of assets. At 252, first inputs (e.g., the inputs 102) defining inventory and supply chain parameters associated with the fleet of assets and the at least one component over a duration of time spanning from a present time to a future time are received. At 254, second inputs (e.g., the time-phased parameters 128) defining at least one time-phased input corresponding to a change associated with at least one of the inventory and supply chain parameters at at least one future time in the duration of time are received. At 256, the first and second inputs are stored in an associated database (e.g., the databases 16 and 18) stored in a memory system (e.g., the memory system 14). At 258, an inventory assessment model (e.g., the inventory assessment model 22) comprising an allocation of the inventory of the at least one component throughout the duration of time at the present time based on the inventory and supply chain parameters throughout the duration of time is generated. At 260, an inventory management plan (e.g., the inventory management plan 24) comprising instructions to maintain a predetermined quantity supply of the at least one component throughout the time duration at the present time based on the inventory and supply chain parameters throughout the duration of time is generated. At 262, outputs (e.g., the outputs 104) comprising the inventory assessment model and the inventory management plan are generated.

What has been described above are examples. It is, of course, not possible to describe every conceivable combination of components or methodologies, but one of ordinary skill in the art will recognize that many further combinations and permutations are possible. Accordingly, the disclosure is intended to embrace all such alterations, modifications, and variations that fall within the scope of this application, including the appended claims. As used herein, the term “includes” means includes but not limited to, the term “including” means including but not limited to. The term “based on” means based at least in part on. Additionally, where the disclosure or claims recite “a,” “an,” “a first,” or “another” element, or the equivalent thereof, it should be interpreted to include one or more than one such element, neither requiring nor excluding two or more such elements.

What is claimed is:

1. A forecasting inventory management system for a fleet of assets, the system comprising:
an input/output (I/O) interface configured to receive inputs defining inventory and supply chain parameters associated with the fleet of assets and at least one component associated with each asset of the fleet of assets over a duration of time spanning from a present time to a future time, the inputs further comprising at least one time-phased input corresponding to a change associated with at least one of the inventory and supply chain parameters at at least one future time in the duration of time, the I/O interface being further configured to provide outputs comprising an inventory assessment model comprising an allocation of the inventory of the at least one component throughout the duration of time;
a memory system configured to store a database defining the inventory and supply chain parameters associated with the fleet of assets and the at least one component of the fleet of assets; and
a forecasting engine configured to generate the inventory assessment model at the present time based on the inventory and supply chain parameters throughout the duration of time.

2. The system of claim 1, wherein the forecasting engine is further configured to generate an inventory management plan at the present time based on the inventory and supply chain parameters throughout the duration of time, the inventory management plan comprises instructions to maintain a predetermined quantity supply of the at least one component throughout the time duration, wherein the outputs comprise the inventory management plan.

3. The system of claim 2, wherein inventory management plan comprises:
ordering instructions for the at least one component throughout the time duration; and
component management instructions corresponding to allocation instructions of the at least one component to each asset of the fleet of assets and to at least one storage location throughout the time duration.

4. The system of claim 2, wherein the inputs comprise hypothetical changes to the inventory and supply chain parameters, wherein the memory system is further configured to maintain the inventory assessment model and to generate a hypothetical inventory assessment model and a hypothetical inventory management plan at the present time based on the hypothetical changes to the inventory and supply chain parameters.

5. The system of claim 4, wherein the hypothetical changes to the inventory and supply chain parameters further comprise costs associated with the fleet of assets and the at least one component, wherein the hypothetical inventory management plan further comprises execution costs for a plurality of mutually exclusive inventory management plan options.

6. The system of claim 2, wherein the inventory management plan further comprises time-based allocation instructions of the predetermined quantity supply of the at least one component to the fleet of assets throughout the time duration.

7. The system of claim 6, wherein the inventory and supply chain parameters comprises:
a plurality of categories of the fleet of assets; and
priority data associated with the plurality of categories of the fleet of assets, wherein the time-based allocation instructions is generated based on the priority data.

8. The system of claim 7, wherein one of the plurality of categories corresponds to a set of assets that are to be deployed at a first future time in the duration of time, wherein the time-based allocation instructions comprises instructions to allocate a portion of the predetermined quantity supply of the at least one component to assets to the set of assets at a second future time in the duration of time, the first future time being subsequent to the second future time.

9. The system of claim 7, wherein the time-based allocation instructions comprises transferring a portion of the predetermined quantity supply of the at least one component from an asset associated with a first one of the plurality of categories to an asset associated with a second one of the plurality of categories.

10. The system of claim 1, wherein the inventory assessment model comprises an allocation of inventory of the at least one component at each of a plurality of supply chain locations associated with the supply chain of the at least one component defined by the second database at each time throughout the time duration.

11. The system of claim 1, wherein the forecasting engine is configured to automatically update the inventory assessment model at the present time in response to subsequently provided inputs provided to the I/O interface.

12. The system of claim 1, wherein the inventory and supply chain parameters comprises:
at least one of an asset repair time associated with each of at least one asset repair facility and a component production time associated with each of at least one component production facility; and
at least one of an asset repair capacity associated with each of the at least one asset repair facility and a component production capacity associated with each of the at least one component production facility.

13. The system of claim 1, wherein the inputs comprises at least one threshold quantity of the at least one component, wherein the inventory assessment model comprises an evaluation of a projected quantity supply of the at least one component relative to the at least one threshold quantity at each time throughout the duration of time.

14. A method for managing inventory of at least one component associated with each of a fleet of assets, the method comprising:
receiving first inputs defining inventory and supply chain parameters associated with the fleet of assets and the at least one component over a duration of time spanning from a present time to a future time;
receiving second inputs defining at least one time-phased input corresponding to a change associated with at least one of the inventory and supply chain parameters at at least one future time in the duration of time;
storing the first and second inputs in an associated database stored in a memory system;
generating an inventory assessment model comprising an allocation of the inventory of the at least one component throughout the duration of time at the present time based on the inventory and supply chain parameters throughout the duration of time;
generating an inventory management plan comprising instructions to maintain a predetermined quantity supply of the at least one component throughout the time duration at the present time based on the inventory and supply chain parameters throughout the duration of time; and
providing outputs comprising the inventory assessment model and the inventory management plan.

15. The method of claim 14, wherein generating the inventory management plan comprises:
generating ordering instructions for the at least one component throughout the time duration; and
generating component management instructions corresponding to allocation instructions of the at least one component to each asset of the fleet of assets and to at least one storage location throughout the time duration.

16. The method of claim 14, further comprising:
receiving third inputs comprising hypothetical changes to the inventory and supply chain parameters;
generating a hypothetical inventory assessment model and a hypothetical inventory management plan at the present time based on the hypothetical changes to the inventory and supply chain parameters while maintaining the inventory assessment model and the inventory management plan.

17. The system of claim 2, wherein the inventory management plan further comprises time-based allocation instructions of the predetermined quantity supply of the at least one component to the fleet of assets throughout the time duration, wherein the inventory and supply chain parameters comprises:
a plurality of categories of the fleet of assets; and
priority data associated with the plurality of categories of the fleet of assets, wherein the time-based allocation instructions is generated based on the priority data.

18. A forecasting inventory management system for a fleet of assets, the system comprising:
a memory system configured to store a database defining inventory and supply chain parameters associated with the fleet of assets and at least one component of the fleet of assets, the inventory and supply chain parameters comprising at least one of an asset repair time associated with each of at least one asset repair facility and a component production time associated with each of at least one component production facility and at least one of an asset repair capacity associated with each of the at least one asset repair facility and a component production capacity associated with each of the at least one component production facility;
an input/output (I/O) interface configured to receive inputs defining the inventory and supply chain parameters associated with the fleet of assets and the at least one component associated with each asset of the fleet of assets over a duration of time spanning from a present time to a future time, the inputs further comprising at least one time-phased input corresponding to a change associated with at least one of the inventory and supply chain parameters at at least one future time in the duration of time, the I/O interface being further configured to provide outputs comprising an inventory assessment model comprising an allocation of inventory of the at least one component at each of a plurality of supply chain locations associated with the supply chain of the at least one component defined by the second database at each time throughout the time duration; and
a forecasting engine configured to generate the inventory assessment model at the present time based on the inventory and supply chain parameters throughout the duration of time.

19. The system of claim 18, wherein the forecasting engine is further configured to generate an inventory management plan at the present time based on the inventory and supply chain parameters throughout the duration of time, the inventory management plan comprising:
ordering instructions for the at least one component throughout the time duration to maintain a predetermined quantity supply of the at least one component throughout the time duration at the present time based on the inventory and supply chain parameters throughout the duration of time; and
component management instructions corresponding to allocation instructions of the at least one component to each asset of the fleet of assets and to at least one storage location throughout the time duration.

20. The system of claim 18, wherein the inputs comprises at least one threshold quantity of the at least one component, wherein the inventory assessment model comprises an evaluation of a projected quantity supply of the at least one component relative to the at least one threshold quantity at each time throughout the duration of time.
